(19) United States
(12) Patent Application Publication
(10) Pub. No.: US 2009/0057301 A1
(43) Pub. Date: Mar. 5, 2009

(54) ELECTRIC INDUCTION HEATING APPARATUS WITH FLUID MEDIUM FLOW THROUGH

(76) Inventor: Jean Lovens, Embourg (BE)

Correspondence Address: PHILIP O. POST;INDEL, INC., PO BOX 157, RANCOCAS, NJ, 08073, US

(21) Appl. No.: 12/198,275

(22) Filed: Aug. 26, 2008

Related U.S. Application Data
(60) Provisional application No. 60/968,332, filed on Aug. 28, 2007.

(51) Int. Cl. H05B 6/10; A21B 1/00

(52) U.S. Cl. 219/645; 219/391

(57) ABSTRACT

Apparatus and method are provided for electric induction heating of a workpiece moving through a chamber that is enclosed by a gas plenum. A fluid flows through the gas plenum and chamber with at least a part of the flow passing through passages in an induction coil that is used to inductively heat the workpiece as it moves through the chamber. The gas plenum and passages are arranged so that gas flow through the passages in the induction coil is directed towards opposing surfaces of the workpiece.

### CROSS REFERENCE TO RELATED APPLICATIONS

This application claims the benefit of U.S. Provisional Application No. 60/968,332, filed Aug. 28, 2007, hereby incorporated by reference in its entirety.

### FIELD OF THE INVENTION

The present invention generally relates to an electric induction heating apparatus wherein an enclosed chamber isolates a workpiece from the surrounding environment while the workpiece passes through the chamber and a fluid medium flow is provided in the chamber.

### BACKGROUND OF THE INVENTION

Electric induction heating apparatus can be provided with an enclosed chamber to isolate an electrically conductive workpiece from the surrounding environment as it moves through the chamber and is inductively heated. One reason for such isolation is to contain hazardous materials that may be produced in the heating process. For example when the workpiece is a metal strip that has been coated with a liquid coating material prior to entry into the chamber, inductively heating the strip in the chamber to bond the coating material to the surface of the strip may release hazardous vapors. Further a fluid medium may be introduced into the enclosed chamber, for example, to assist in the drying of the coating material on the surface of the strip, or to extract hazardous materials produced in the heating process from the chamber.

With reference to FIG. 1(a), FIG. 1(b) and FIG. 1(c) herein, and element numbers used in Japanese patent publication JP 63-4873 (1988), said publication discloses an enclosed electric induction heating furnace (3). Prior to entry into furnace (3), the workpiece, metal strip (1) passes through coating apparatus (2) wherein a coating material is applied to the surface of the workpiece. The furnace comprises a plurality of induction heating zones (7) that are spaced apart by upper hot air supply passages (12) and lower hot air exhaust ports (16). Each induction heating zone comprises a solenoidal induction coil (6) (with internal passage for a cooling medium and external thermal insulation) that surrounds the strip as it passes through the zone, and an upper hot air supply passage (12) that supplies hot air between the windings of the solenoidal coil in each heating zone. The supplied hot air through air supply passages (12) in each heating zone, and each adjacent hot air supply/exhaust zone, passes through baffles (11) onto the upper side of the strip in the furnace to prevent formation of dew from vapors released by the coating material in the furnace, and to prevent solid contaminates from depositing on the upper surface of the strip as it passes through the furnace. Upon exit from the furnace the strip passes through a cooling apparatus (4) and is rolled into product coil (5). The air handling system comprises air supply pump (13), supply filter (14), supply heat exchanger (15), and exhaust vapor processing apparatus (17). Japanese patent publication JP 63-4873 discloses a unidirectional flow of hot air from the upper regions of furnace (3) to the lower regions of the furnace.

With reference to U.S. Pat. No. 5,768,799 (1998), and element numbers used in said patent, an enclosed electric induction furnace is disclosed wherein a heated gas is injected into the inlet and outlet of the furnace by supply duct (7) and evacuated via exhaust duct (6) located between adjacent induction heating zones. Each heating zone comprises solenoidal induction coil (5) which is physically isolated from the flow of the heated gas and the interior of the enclosed electric induction furnace by gastight walled sections. U.S. Pat. No. 5,768,799 discloses a unidirectional flow of a preheated gas from the lower opposing ends of the furnace to the upper central region of the furnace.

It is one object of the present invention to provide an induction heating apparatus with an enclosed heating chamber wherein a fluid medium, such as a gas, can be supplied over the opposing surface areas of the section of a workpiece in each heating zone of the apparatus.

### BRIEF SUMMARY OF THE INVENTION

In one aspect the present invention is an induction heating apparatus for, and method of, inductively heating a workpiece, such as an electrically conductive strip, moving through a chamber. The outer boundary of the chamber is formed from a gas plenum that surrounds a section of the workpiece moving through the chamber. At least one induction coil is located in the plenum and positioned around the section of the workpiece in the chamber. A plurality of passages is provided through the induction coil. If the coil is a multi-turn solenoidal coil, the passages are formed by openings between one or more turns of the thermally insulated multi-turn induction coil. If the coil is a single turn coil, the passages are formed by openings in the single turn of the coil. A fluid medium, such as a gas, can be introduced into the gas supply plenum surrounding the induction coil so that gas flows through the passages in the induction coil can be directed towards the opposing surfaces of the strip. The gas is removed from the chamber by a gas exhaust plenum that can be alternatively located adjacent to the gas supply plenum, or around the gas supply plenum.

The above and other aspects of the invention are set forth in this specification and the appended claims.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1(a), FIG. 1(b) and FIG. 1(c) are one example of a prior art electric induction heating apparatus.

FIG. 2(a) illustrates in longitudinal cross section one example of the electric induction heating apparatus of the present invention.

FIG. 2(b) and FIG. 2(c) illustrate in cross section the apparatus in FIG. 3(a) through lines A-A and B-B in FIG. 3(a), respectively.

FIG. 3 illustrates in longitudinal cross section another example of the electric induction heating apparatus of the present invention.

FIG. 4 is a perspective view of one example of a single turn inductor used in an electric induction heating apparatus of the present invention.

FIG. 5 illustrates in longitudinal cross section another example of the electric induction heating apparatus of the present invention.

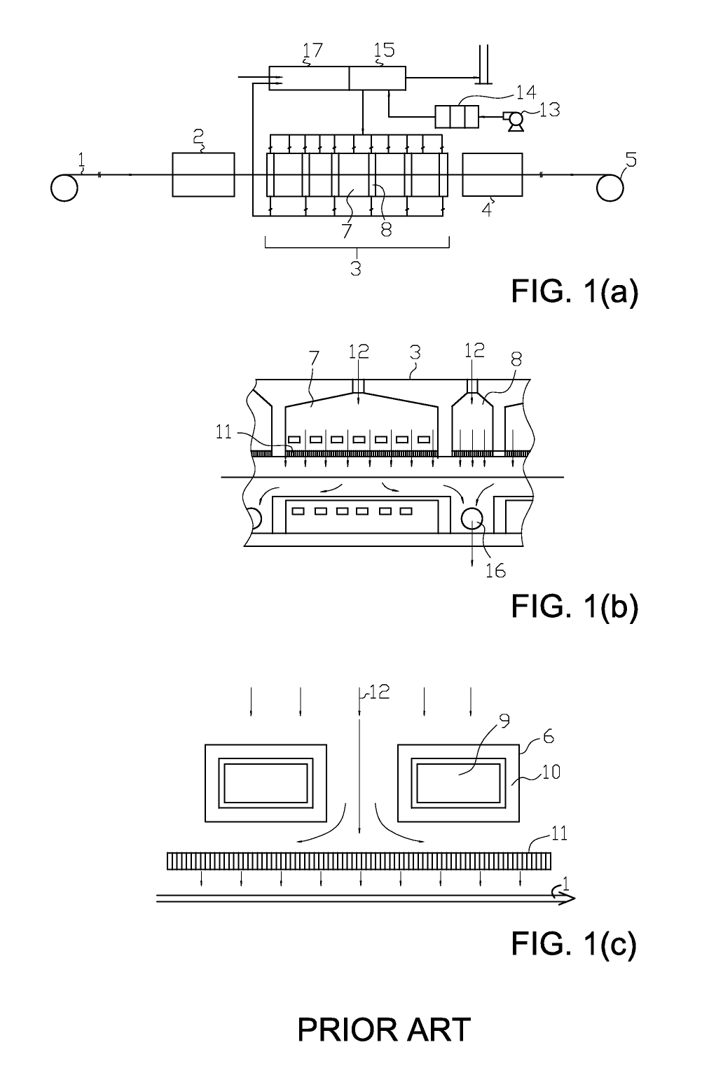

### DETAILED DESCRIPTION OF THE INVENTION

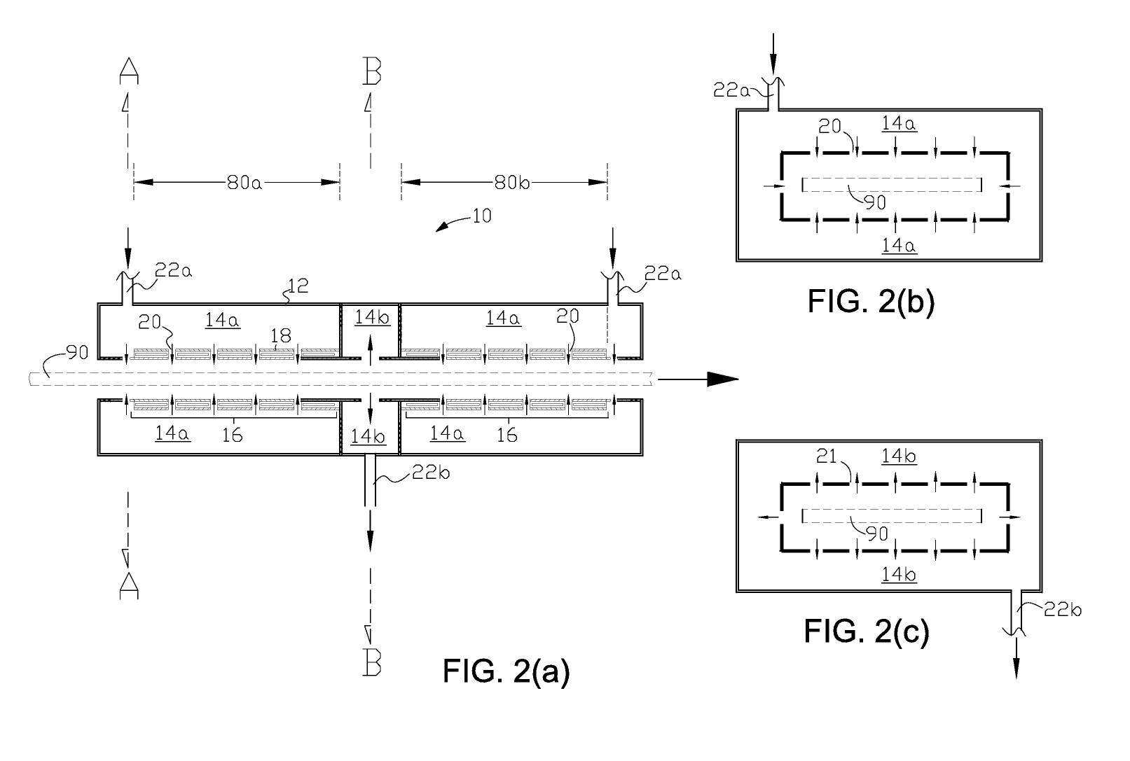

Referring now to the figures, wherein like numerals indicate like elements, there is shown in FIG. 2(a), FIG. 2(b) and FIG. 2(c) one example of induction heating apparatus 10 of the present invention. Induction heating apparatus 10 has an outer boundary 12 that forms a gas plenum comprising gas supply regions 14a and gas exhaust regions 14b which are substantially enclosed except for the entry and exit ports for a workpiece, for example, electrically conductive metal strip 90 that passes through the apparatus. Outer boundary 12 may be formed from a singular structure or be assembled from parts that are joined together, for example, by flange sections. One or more induction heating zones are provided in the apparatus. For the non-limiting example in FIG. 2(a), FIG. 2(b) and FIG. 2(c), two heating zones 80a and 80b are provided. Each induction heating zone comprises solenoidal induction coil 16 with thermal insulation 18 surrounding each turn of the coil. Passages 20 are provided between at least some of the adjacent windings of the coil. A suitable source of alternating current (ac) is supplied to each coil so that current flowing through the coil establishes a flux field that couples with the strip to inductively heat the strip. The ac source may either be a single power supply or multiple power supplies each connected to one of the induction coils. In the non-limiting example of the invention shown in FIG. 2(a), FIG. 2(b) and FIG. 2(c), a fluid medium, such as a gas, flows through the gas plenum from inlets 22a to outlet passages 20 with the arrows in the figures indicating gas flow. Each thermally insulated induction coil is located in the gas plenum so that supply gas flows into the gas plenum and through passages 20. In this two heating zone arrangement, preferably, but not by way of limitation, evacuation of the supply gas from the gas plenum is via exhaust plenum 14b located between the two induction heating zones, and then through exhaust port 22b, which can be connected to a contaminated gas processing apparatus such as an incinerator.

In the above non-limiting example of the present invention each heating zone is formed around a gas supply plenum disposed between a gas exhaust plenum and the plurality of openings, or passages 20, between at least some of the adjacent windings of the induction coil allow the gas, or fluid medium, to be directed towards the opposing surface areas of the sections of the workpiece in the heating zones, as seen, for example, in FIG. 2(b). In the gas exhaust plenum, the gas exhaust regions surround the workpiece so that gas can be exhausted from the heating zone in all directions around the workpiece, as seen, for example, in FIG. 2(c).

Referring to FIG. 2(b) while passages 20 are provided in the top, bottom and opposing sides of the induction coil, in other examples of the invention the passages may be provided in the opposing top and bottom regions of the induction coil, or otherwise suitably arranged, to provide a gas flow towards the opposing surfaces of the workpiece. Referring to FIG. 2(c) while exhaust passages 21 into gas exhaust regions 14b of the gas exhaust plenum are shown surrounding all sides of the workpiece, in other examples of the invention, the exhaust passages may be limited to one or more sides of the workpiece. Further in other examples of the invention the exhaust gas plenum may be open to the workpiece moving through the exhaust gas plenum, rather than connected to the workpiece region by discrete exhaust passages 21.

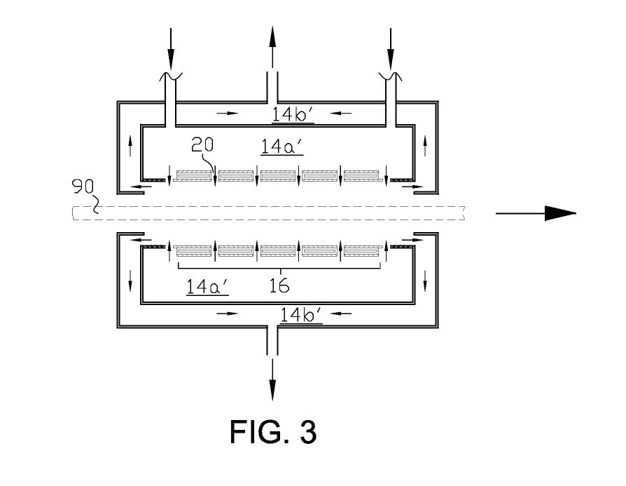

As shown in FIG. 3 in other examples of the invention, for example where the electric induction heating apparatus has a single induction heating zone, gas exhaust plenum 14b′ may at least partially surround gas supply plenum 14a′ and draw gas from the opposing ends of the induction heating apparatus as shown in FIG. 3 with the arrows indicating gas flow. In this non-limiting example of the present invention the fluid medium is supplied over the opposing surface areas of the section of the workpiece in the heating zone through passages 20 and exhausted at the opposing ends of the gas plenum through the surrounding gas exhaust plenum.

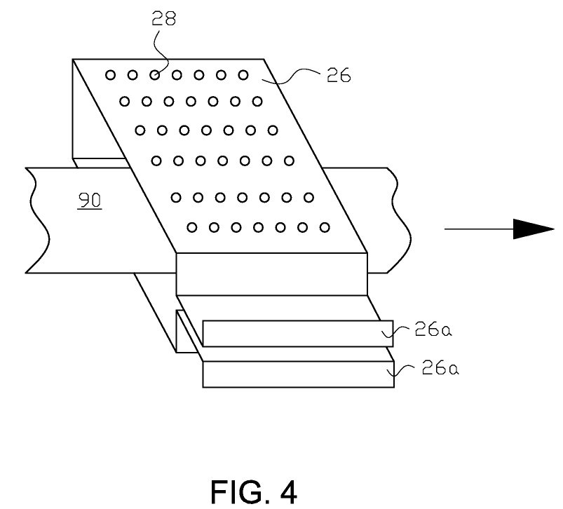

In all examples of the invention the multi-turn solenoidal coil in each heating zone can be replaced by a single turn inductor 26, for example, as illustrate in FIG. 4. A suitable source of ac power can be provided to terminals 26a and 26b of the inductor. In these examples a plurality of passages 28 can be formed in the single turn induction coil as a plurality of holes, or openings, to provide flow paths for the gas from the gas supply plenum towards the opposing surfaces of the workpiece. Passages 28 can be provided in the opposing top and bottom sides of the inductor, or otherwise suitably arranged, so that gas flow is directed towards opposing surfaces of the workpiece. The single turn inductor can alternatively replace the multi-turn coil in all examples of the invention.

In all examples of the invention the rate of gas supply and exhaust can be regulated to change the gas pressure in the chamber from a positive pressure to a negative pressure condition.

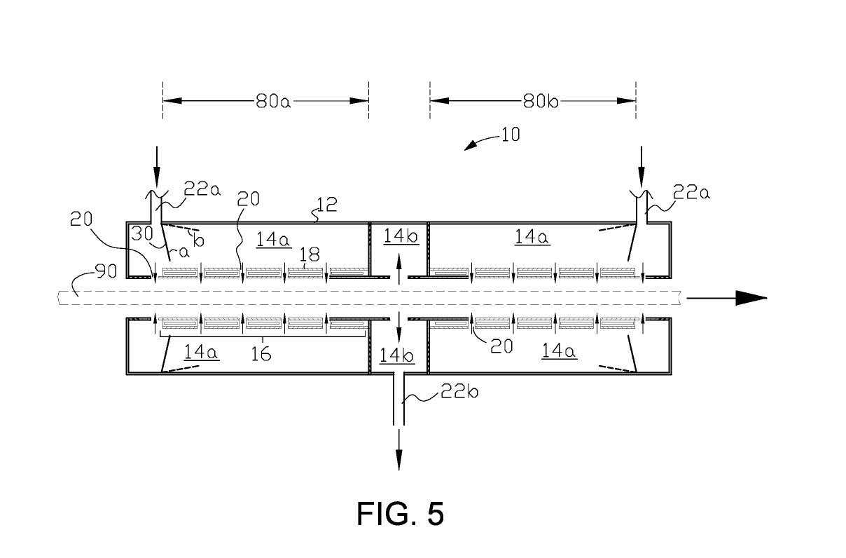

In all examples of the invention one or more of the passages 20 or 28 can be regulated to control the flow of air over selected portions of the strip in the chamber in each of the heating zones. For example flow damper 30 in FIG. 5 may be used to control flow relative to the passage 20 at the end of the inductor and the other passages 20 through the inductor. Damper position “a” (diagrammatically shown in solid line in FIG. 5) directs most of the supply air to the end passage, and damper position “b” (diagrammatically shown in dashed line in FIG. 5) directs the supply air more evenly along the length of the heating zone. A series of coordinated flow dampers may be used to dynamically control the gas flow through selected groups of passages 20 or 28 in response to changing requirements of the strip moving through the apparatus.

The above examples of the invention have been provided merely for the purpose of explanation and are in no way to be construed as limiting of the present invention. While the invention has been described with reference to various embodiments, the words used herein are words of description and illustration, rather than words of limitations. Although the invention has been described herein with reference to particular means, materials and embodiments, the invention is not intended to be limited to the particulars disclosed herein; rather, the invention extends to all functionally equivalent structures, methods and uses. Those skilled in the art, having the benefit of the teachings of this specification, may effect numerous modifications thereto, and changes may be made without departing from the scope of the invention in its aspects.

1. An electric induction heating apparatus comprising:
a gas plenum comprising a gas exhaust plenum adjacent to a gas supply plenum;
at least one solenoidal induction coil disposed within the gas supply plenum, the interior of the at least one solenoidal coil forming a passage for a workpiece moving through the gas plenum, the at least one solenoidal induction coil having a plurality of openings, the gas supply plenum surrounding the exterior of the at least one solenoidal coil;
at least one alternating current source connected to the at least one solenoidal induction coil;
at least one gas supply port in communication with the interior of the gas supply plenum; and
at least one gas exhaust port in communication with the interior of the gas exhaust plenum;
whereby a gas flow path is established from the at least one gas supply port to the gas supply plenum surrounding the exterior of the at least one solenoidal coil, the gas flow advancing through the plurality of openings in the at least one solenoidal coil into the passage and towards the opposing surfaces of the workpiece and then into the adjacent gas exhaust plenum and through the at least one gas exhaust port.

2. The apparatus of claim 1 wherein the at least one solenoidal induction coil comprises a multi-turn induction coil and the plurality of openings are formed between at least some of the adjacent turns of the coil.

3. The apparatus of claim 1 wherein the at least one solenoidal induction coil comprises a single turn coil and the plurality of openings are formed by passages in the single turn coil.

4. The apparatus of claim 1 further comprising at least one damper located in the supply gas plenum to control the gas flow path through selected openings in the plurality of openings.

5. An electric induction heating apparatus comprising:
a gas plenum comprising a gas exhaust plenum disposed between a first and second gas supply plenum;
at least one solenoidal induction coil disposed within each one of the first and second gas supply plenum, the interior of each one of the at least one solenoidal coils forming a passage for a workpiece moving through the gas plenum, each one of the at least one solenoidal induction coils having a plurality of openings, the first and second gas supply plenum surrounding the exterior of the at least one solenoidal coil respectively disposed in the first and second gas supply plenum;
at least one alternating current source connected to each one of the at least one solenoidal induction coil in the first and second gas supply plenum;
at least one gas supply port in communication with the interior of each one of the first and second gas supply plenum; and
at least one gas exhaust port in communication with the interior of the gas exhaust plenum;
whereby a gas flow path is established from the at least one gas supply port to the first and second gas supply plenum, the gas flow advancing through the plurality of openings in each one of the at least one solenoidal coils into the passage and towards the opposing surfaces of the workpiece and then into the gas exhaust plenum and through the at least one gas exhaust port.

6. The apparatus of claim 5 wherein the at least one solenoidal induction coil comprises a multi-turn induction coil and the plurality of openings are formed between at least some of the adjacent turns of the coil.

7. The apparatus of claim 5 wherein the at least one solenoidal induction coil comprises a single turn coil and the plurality of openings are formed by passages in the single turn coil.

8. The apparatus of claim 5 further comprising at least one damper located in the supply gas plenum to control the gas flow path through selected openings in the plurality of openings.

9. A method of electric induction heating of an electrically conductive strip material in a chamber formed from a gas plenum comprising a gas exhaust plenum adjacent to at least one gas supply plenum, the chamber having at least one solenoidal induction coil disposed in each one of the at least one gas supply plenum and exteriorly surrounded by the gas supply plenum, the method comprising the steps of:
passing the strip material through the interior of each one of the at least one solenoidal coils;
supplying alternating current to each one of the at least one solenoidal induction coils to generate a magnetic flux that couples with the strip material to inductively heat the strip material;
injecting a gas into the at least one gas supply plenum surrounding the at least one solenoidal coil and through a plurality of openings in each one of the at least one solenoidal induction coils towards the opposing surfaces of the strip; and
exhausting the gas into the adjacent gas exhaust plenum.

10. The method of claim 9 further comprising the step of controlling the flow of gas through selected openings in the plurality of openings.

11. An electric induction heating apparatus comprising:
a gas plenum comprising a gas exhaust plenum at least partially surrounding a gas supply plenum;
at least one solenoidal induction coil disposed within the gas supply plenum, the interior of the at least one solenoidal coil forming a passage for a workpiece moving through the gas plenum, the at least one solenoidal induction coil having a plurality of openings, the gas supply plenum surrounding the exterior of the at least one solenoidal coil;
at least one alternating current source connected to the at least one solenoidal induction coil;
at least one gas supply port in communication with the interior of the gas supply plenum; and
at least one gas exhaust port in communication with the interior of the gas exhaust plenum;
whereby a gas flow path is established from the at least one gas supply port to the gas supply plenum surrounding the exterior of the at least one solenoidal coil, the gas flow advancing through the plurality of openings in the at least one solenoidal coil into the passage and towards the opposing surfaces of the workpiece and then into the surrounding gas exhaust plenum and through the at least one gas exhaust port.

12. The apparatus of claim 11 wherein the at least one solenoidal induction coil comprises a multi-turn induction coil and the plurality of openings are formed between at least some of the adjacent turns of the coil.

13. The apparatus of claim 11 wherein the at least one solenoidal induction coil comprises a single turn coil and the plurality of openings are formed by passages in the single turn coil.

14. The apparatus of claim 11 further comprising at least one damper located in the supply gas plenum to control the gas flow path through selected openings in the plurality of openings.

15. A method of electric induction heating of an electrically conductive strip material in a chamber formed from a gas plenum comprising a gas exhaust plenum at least partially surrounding a gas supply plenum, the chamber having at least one solenoidal induction coil disposed in the gas supply plenum and exteriorly surrounded by the gas supply plenum, the method comprising the steps of:
passing the strip material through the interior of the at least one solenoidal coil;
supplying alternating current to the at least one solenoidal induction coil to generate a magnetic flux that couples with the strip material to inductively heat the strip material;
injecting a gas into the gas supply plenum surrounding the at least one solenoidal coil and through a plurality of openings in the at least one solenoidal induction coil towards the opposing surfaces of the strip; and
exhausting the gas into the surrounding gas exhaust plenum.

16. The method of claim 15 further comprising the step of controlling the flow of gas through selected openings in the plurality of openings.
